(19) United States
(12) Patent Application Publication
(10) Pub. No.: US 2005/0196523 A1
(43) Pub. Date: Sep. 8, 2005

(54) Electroless plating method and apparatus, and computer storage medium storing program for controlling same

(75) Inventor: Yoshinori Marumo, Nirasaki-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TOKYO ELECTRON LIMITED, Tokyo (JP)

(21) Appl. No.: 11/100,393

(22) Filed: Apr. 7, 2005

Related U.S. Application Data
(63) Continuation-in-part of application No. PCT/JP03/06500, filed on May 23, 2003.

(30) Foreign Application Priority Data
Oct. 7, 2002 (JP) 2002-293913

(51) Int. Cl. C25D 5/02; B05D 1/00

(52) U.S. Cl. 427/8; 427/437; 118/697

(57) ABSTRACT

In an electroless plating method and apparatus, an electroless plating solution is supplied onto a substrate, a reaction acceleration condition is applied to the electroless plating solution to accelerate a reaction, and a coating is formed on the substrate by using the electroless plating solution to which the reaction acceleration condition has been applied. Further, In an electroless plating method and apparatus, a first coating is formed on a substrate by using a first electroless plating solution at a first coating formation rate, and a second coating is formed on the substrate, on which the first coating has been formed, by using a second electroless plating solution at a second coating formation rate higher than the first coating formation rate. The methods allow a coating to be formed in a recess portion, uniformly.

This application is a Continuation-In-Part Application of PCT International Application No. PCT/JP03/06499 filed on May 23, 2003, which designated the United States.

### FIELD OF THE INVENTION

The present invention relates to an electroless plating method and apparatus for forming an electrolessly plated coating, and a computer storage medium storing a program for controlling same.

### BACKGROUND OF THE INVENTION

In a fabrication of a semiconductor device, there is performed a formation of a wiring on a semiconductor substrate.

Along with a recent trend of high integration of semiconductor devices, miniaturization of the wiring has been progressed and fabrication technique thereof has been accordingly developed. For example, as a method for forming a copper wiring, there has been utilized a dual damascene method wherein a copper seed layer is formed by a sputtering and a groove is buried by an electroplating to form a wiring and an interlayer connection. In this method, it is difficult to perform the electroplating on a surface where the seed layer is not formed.

Meanwhile, as a plating method wherein the seed layer is not required, there is an electroless plating method. In the electroless plating method for forming a coating by a chemical reduction, the formed coating acts as a self-catalyst, so that the coating made of a wiring material can be formed continuously. In accordance with the electroless plating, it is unnecessary to form the seed layer in advance, and there is a reduced concern that the coating becomes non-uniformed due to non-uniformity of the seed layer (particularly, step coverage in recess and protrusion portions).

As for the electroless plating, following technologies have been disclosed:

Japanese Patent Laid-open Application No. 2001-73157 (p. 4, FIG. 1)

Japanese Patent Laid-open Application No. 2001-342573 (p. 4 and 5, FIGS. 2 and 3)

### SUMMARY OF THE INVENTION

In case when forming a coating in a fine recess portion, such as, e.g., a via-hole, a trench or the like, through an electroless plating, a void is produced therein, and thus uniformity in the formation of the coating inside the recess portion may be deteriorated. The reason is that, in the electroless plating, the formation of the coating is performed by using a plating solution being contacted with a substrate that has a catalytic activity, and thus the formation of the coating is started before the inside of the recess portion is filled with the plating solution.

It is, therefore, an object of the present invention to provide an electroless plating method and apparatus, and a computer storage medium storing a program for controlling same, the electroless plating method being capable of improving uniformity in a coating to be formed.

In accordance with one aspect of the present invention, for achieving the aforementioned object, there are provided an electroless plating method and a computer storage medium storing a program for controlling same, the electroless plating method including: a plating solution supplying step of supplying an electroless plating solution onto a substrate; a reaction acceleration condition applying step of applying a reaction acceleration condition for accelerating a reaction to the electroless plating solution supplied onto the substrate at the plating solution supplying step; and a coating formation step of forming a coating on the substrate by using the electroless plating solution to which the reaction acceleration condition has been applied at the reaction acceleration condition applying step.

The formation of a coating is started by supplying the electroless plating solution and applying the reaction acceleration condition. At the plating solution supplying step (before the reaction acceleration condition is applied), the formation of the coating is not started yet, and if any, the formation rate thereof is small. For the same reason, e.g., a recess portion may be filled with the electroless plating solution by spreading the electroless plating solution over the whole substrate before a real formation of a coating is performed. Since the electroless plating is performed in the state where the electroless plating solution has spread widely, the uniformity in the electrolessly plated coating can be improved.

(1) Here, the reaction acceleration condition may be realized by increasing a temperature of the electroless plating solution. The reaction of the electroless plating solution is accelerated by increasing the temperature, and the increase in the temperature may be carried out by heating the electroless plating solution by using the substrate (through the substrate) or radiant heat. Further, the increase in the temperature may be realized by controlling the temperature of the electroless plating solution supplied onto the substrate.

(2) The reaction acceleration condition may be realized by changing a composition of the electroless plating solution.

For example, the formation rate of the coating may be changed by changing a concentration or pH of a metal salt.

The change in the composition of the electroless plating solution may be realized by changing an electroless plating solution to be supplied onto the substrate, or by changing a mixing ratio of plural liquid chemicals forming the electroless plating solution to be supplied onto the substrate.

In accordance with another aspect of the present invention, there are provided an electroless plating method and a computer storage medium storing a program for controlling same, the electroless plating method including: a first coating formation step of forming a first coating on a substrate by using a first electroless plating solution at a first coating formation rate; and a second coating formation step of forming a second coating on the substrate, on which the first coating has been formed at the first coating formation step, by using a second electroless plating solution at a second coating formation rate higher than the first coating formation rate.

At the first and the second coating formation step, the first and the second coating are formed by using the first and the second electroless plating solution at the first and the second coating formation rate, respectively. Since the first coating formation rate is smaller than the second coating formation rate, a coating may be formed in a relatively fine pattern on the substrate by using the first electroless plating solution, and then, the coating may be formed rapidly by using the second electroless plating solution. As a result, the formation of the coating on the substrate may be realized uniformly without lengthening the processing time.

(1) The electroless plating method may further comprise, prior to the second coating formation step, an electroless plating solution removal step of removing from the substrate the first electroless plating solution which has been used in the first coating formation step.

By removing the first electroless plating solution from the substrate, it is possible to prevent the first electroless plating solution from being mixed into the second electroless plating solution.

(2) The first and the second plating solution may be supplied from different plating solution storing units, respectively.

By changing the plating solution storing units, which supply the electroless plating solution, the first and the second plating solution may be properly supplied.

(3) The first and the second plating solution may be supplied via a liquid chemical mixing unit for mixing plural liquid chemicals.

By changing a mixing ratio of the liquid chemicals in the liquid chemical mixing unit, the first and the second plating solution may be properly supplied.

In accordance with still another aspect of the present invention, there is provided an electroless plating apparatus including: a plating solution supply unit for supplying an electroless plating solution onto a substrate; a reaction acceleration condition applying unit for applying a reaction acceleration condition to the electroless plating solution supplied onto the substrate by the plating solution supplying unit; and a coating formation unit for forming a coating on the substrate by using the electroless plating solution to which the reaction acceleration condition has been applied by the reaction acceleration condition applying unit.

In accordance with still another aspect of the present invention, there is provided an electroless plating apparatus including: a first coating formation unit for forming a first coating on a substrate by using a first electroless plating solution at a first coating formation rate; and a second coating formation unit for forming a second coating on the substrate, on which the first coating has been formed by the first coating formation unit, by using a second electroless plating solution at a second coating formation rate higher than the first coating formation rate.

### BRIEF DESCRIPTION OF THE DRAWINGS

The above and other objects and features of the present invention will become apparent from the following description of preferred embodiments given in conjunction with the accompanying drawings, in which:

FIG. 1 provides a flowchart for showing a sequence of an electroless plating method in accordance with a first embodiment;

FIGS. 2A to 2C present cross sectional views for showing cross sectional statues of the wafer W for respective steps of FIG. 1;

FIG. 3 is a partial cross sectional view for showing an electroless plating apparatus used for the electroless plating of FIG. 1;

FIG. 4 offers a partial cross sectional view showing a state where the wafer W and the like installed in the electroless plating apparatus of FIG. 3 are tilted;

FIG. 5 is a partial cross sectional view for showing a status of the electroless plating apparatus in case of performing the electroless plating by following the sequence described in FIG. 1;

FIG. 6 is a partial cross sectional view for showing a status of the electroless plating apparatus in case of performing the electroless plating by following the sequence shown in FIG. 1;

FIG. 7 is a partial cross sectional view for showing a status of the electroless plating apparatus in case of performing the electroless plating by following the sequence described in FIG. 1;

FIG. 8 is a partial cross sectional view for showing a status of the electroless plating apparatus in case of performing the electroless plating by following the sequence described in FIG. 1;

FIG. 9 is a partial cross sectional view for showing a status of the electroless plating apparatus in case of performing the electroless plating by following the sequence described in FIG. 1;

FIG. 10 is a partial cross sectional view for showing a status of the electroless plating apparatus in case of performing the electroless plating by following the sequence described in FIG. 1;

FIG. 11 is a partial cross sectional view for showing a status of the electroless plating apparatus in case of performing the electroless plating by following the sequence described in FIG. 1;

FIG. 12 offers a flowchart for showing a sequence of an electroless plating method in accordance with a second embodiment;

FIGS. 13A to 13C provide cross sectional views for showing cross sectional statuses of the wafer W for respective steps of FIG. 12;

FIG. 14 is a partial cross sectional view for showing a status of the electroless plating apparatus in case of performing the electroless plating by following the sequence described in FIG. 12;

FIG. 15 is a partial cross sectional view for showing a status of the electroless plating apparatus in case of performing the electroless plating by following the sequence described in FIG. 12; and

FIG. 16 is a partial cross sectional view for showing a status of the electroless plating apparatus in case of performing the electroless plating by following the sequence described in FIG. 12.

### DETAILED DESCRIPTION OF THE PREFERRED EMBODIMENTS

Hereinafter, an electroless plating method in accordance with preferred embodiments of the present invention will be described in detail with reference to the accompanying drawings.

### First Embodiment

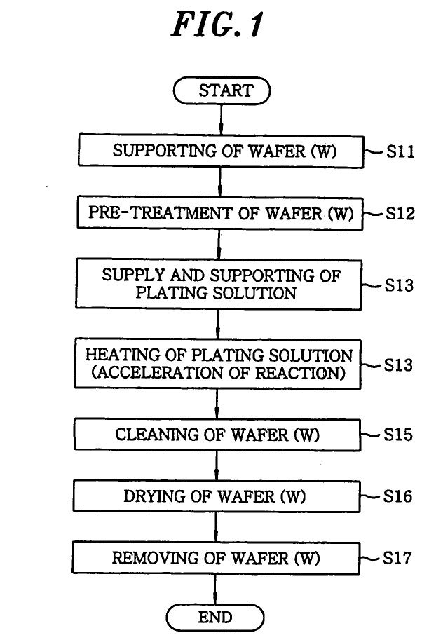

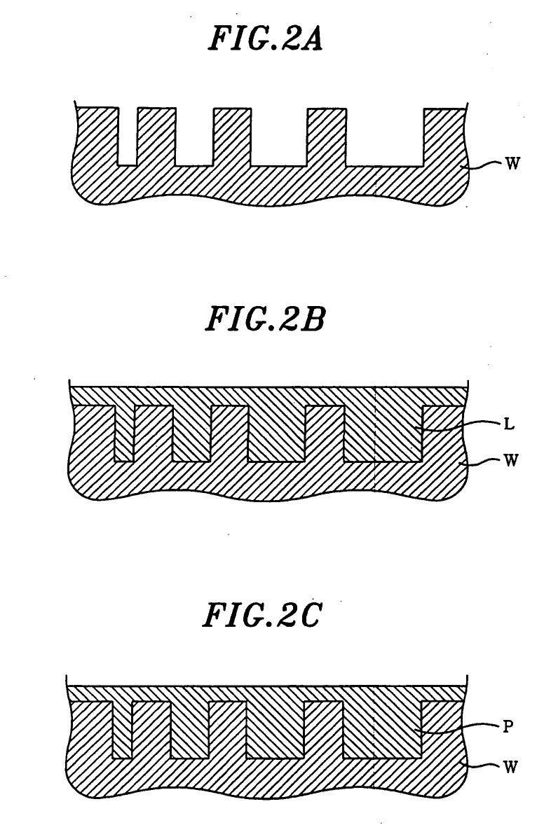

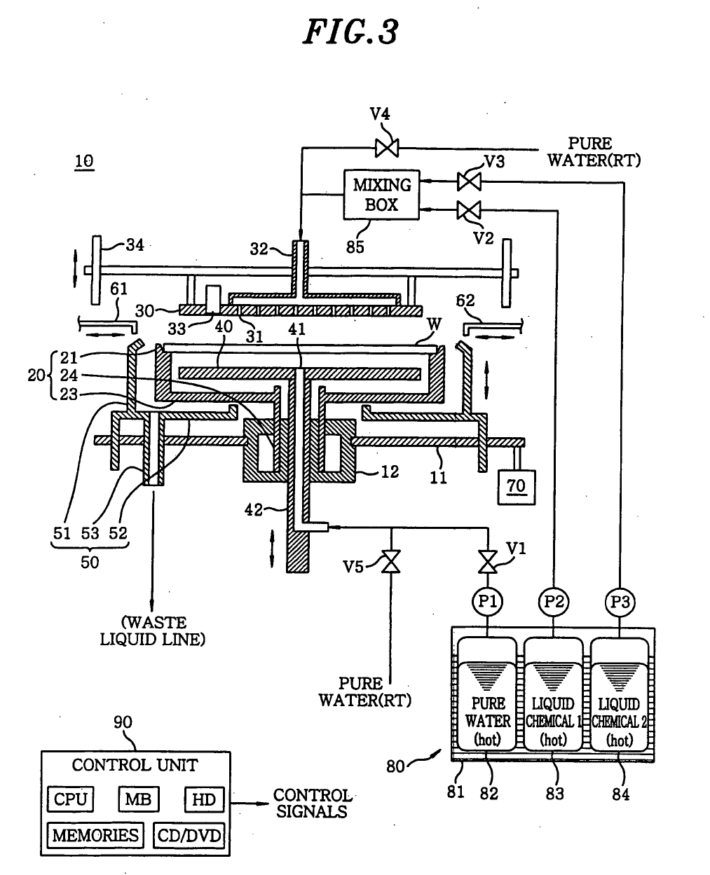

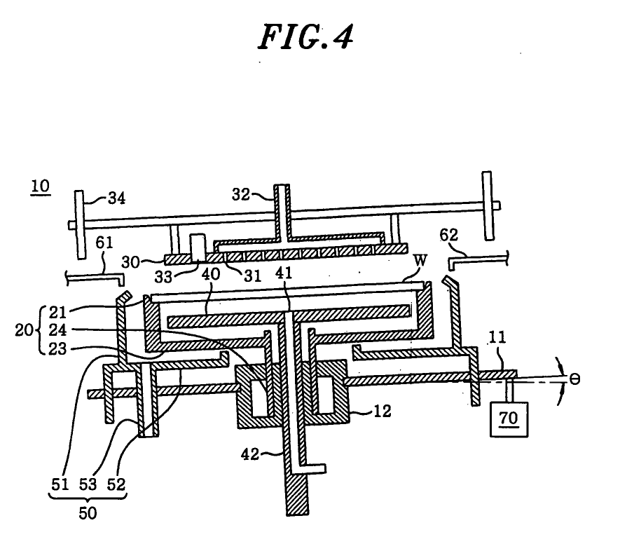

FIG. 1 is a flowchart for showing an exemplary sequence of an electroless plating method in accordance with the first embodiment. Further, FIGS. 2A to 2C present cross sectional views showing cross sectional statues of the wafer W, which is processed by following the sequence described in FIG. 1. Still further, FIG. 3 is a partial cross sectional view for showing an exemplary electroless plating apparatus 10 capable of performing an electroless plating by following the sequence described in FIG. 1.

First, a processing will now be roughly explained with reference to FIGS. 2A-2C (details will be discussed later).

A plating solution L is supplied onto a wafer W having a recess portion (FIG. 2A) and kept therein (step S13 and FIG. 2B). Thereafter, the plating solution L is heated to accelerate a reaction to thereby form a coating P on the wafer W (step S14 and FIG. 2C).

At step S13, the plating solution L, which has been supplied onto the wafer W and kept thereonto, may spread over the whole wafer W containing the recess portion. Subsequently, the plating solution L is heated to form a coating, at step S14. Since the electroless plating is performed in the state where the plating solution L has spread widely, the uniformity in the formation of the coating may be improved.

(Details of the Electroless Plating Apparatus)

First, the electroless plating apparatus will now be described.

In the electroless plating apparatus 10, an electroless plating processing, a pre-treatment thereof, a cleaning processing after plating and a dry processing can be performed on the wafer W of a substrate by using a processing solution.

As for the processing solution, various liquids such as liquid chemicals for the pre-treatment and the post-treatment of the plating, pure water and the like, as well as the liquid chemical for the electroless plating can be employed.

As for the liquid chemical for use in the electroless plating (electroless plating solution), the following materials may be used by being mixed with each other and resolved in the pure water.

1) Metal salt: It is a material for providing metal ions forming a coating. In case of a copper coating, metal salt is, e.g., copper sulfate, copper nitrate, or copper chloride.

2) Complexing agent: It is a material to convert a metal into a complex such that metal ions are not deposited as hydrides under strong alkaline condition to thereby improve stability of the metal in a solution. As for the complexing agent, there may be used, e.g., HEDTA, EDTA, and ED as an amine based material;. and citric acid, tartaric acid and gluconic acid as an organic material.

3) Reducing agent: It is a material for catalytically reducing and depositing metal ions. As for the reducing agent, there may be used, e.g., formaldehyde, hypophosphite, glucoxyl acid, nitrate (cobalt (II) nitrate, etc.), dimethylamine borane, stannic chloride, or boron hydride compound.

4) Stabilizer: It is a material for preventing a plating solution from being naturally decomposed due to non-uniformity of oxide (cupric oxide in case of a copper coating). As for the stabilizer, there may used as nitrogen based material, e.g., bipyridyl, cyanide compound, thiourea, O-Phenanthroline, or neocuproine. Herein, bipyridyl preferentially forms a complex with, e.g., monovalent copper.

5) pH buffer: It is a material for suppressing variation in pH while a reaction of a plating solution progresses. As for the pH buffer, there may be used, e.g., boric acid, carbonic acid or oxycarboxylic acid.

6) Additive: It is a material for facilitating or suppressing deposition of a coating, or performing a modification on a surface or a coating.

As a material for suppressing the deposition rate of the coating, stabilizing a plating solution and improving the characteristic of the coating, there may be used, e.g., thiosulfuric acid or 2-MBT.

As a material for lowering surface tension of a plating solution to make the plating solution be placed uniformly on a surface of a wafer W, there may be used, e.g., polyalkylene glycol or polyethylene glycol as a nonionic surfactant material.

As shown in FIG. 3, the electroless plating apparatus 10 includes a base 11, a hollow motor 12, a wafer chuck 20 of a substrate supporting unit, an upper plate 30, a lower plate 40, a cup 50, nozzle arms 61 and 62, a substrate inclining mechanism 70 for regulating a tilt of a substrate and a solution supply unit 80. Here, the hollow motor 12, the wafer chuck 20, the upper plate 30, the lower plate 40, the cup 50 and the nozzle arms 61 and 62 are directly or indirectly connected to the base 11, so that they are moved with the base 11 tilted by the substrate inclining mechanism 70.

The wafer W is maintained and fixed by the wafer chuck 20, which is formed of plural wafer supporting claws 21, a wafer chuck bottom plate 23 and a wafer chuck supporting portion 24.

The plural wafer supporting claws 21 are disposed on an outer periphery of the wafer chuck bottom plate 23 to maintain and fix the wafer W.

The wafer chuck bottom plate 23 connected to the upper surface of the wafer chuck supporting portion 24 is of a substantially circular flat plate, and disposed on the bottom surface of the cup 50.

The wafer chuck supporting portion 24 of a substantially cylindrical shape is fitted in a circular opening formed in the wafer chuck bottom plate 23, and configured as a rotation axis of the hollow motor 12. As a result, it is possible to rotate the wafer chuck 20 by operating the hollow motor. 12 while maintaining the wafer W.

The upper plate 30 of a substantially circular flat plate has a heater (not shown), one or more processing solution injection openings 31, a processing solution introduction port 32 and a temperature measuring mechanism 33, and is connected to an elevating mechanism 34.

The heater is a heating unit, such as a heating wire or the like, for heating the upper plate 30. The caloric power of the heater is controlled by a controller (not shown), based on a temperature measurement result of the temperature measuring mechanism 33, such that the upper plate 30, and further, the wafer W are maintained at desired temperatures (e.g., in the range from room temperature to about 60° C.), respectively.

The one or more processing solution injection openings 31 are formed at a lower surface of the upper plate 30, through which the processing solution introduced from the processing solution introduction port 32 is to be discharged.

The processing solution introduction port 32 is placed at an upper side of the upper plate 30; and the processing solution introduced thereinto is discharged through the processing solution injection openings 31. As for the processing solution to be introduced into the processing solution introduction port 32, there may be used pure water (RT: room temperature), or heated liquid chemicals 1 and 2 (e.g., in the range from room temperature to about 60° C.). Further, liquid chemicals 1 and 2 to be mixed in a mixing box 85 explained hereinafter (multiple liquid chemicals containing other liquid chemicals may be mixed, if necessary) may flow into the processing solution introduction port 32.

The temperature measuring mechanism 33 is a temperature measurement unit such as a thermocouple or the like, buried into the upper plate 30, for measuring a temperature of the upper plate 30.

The elevating mechanism 34, connected to the upper plate 30, vertically moves the upper plate 30 while allowing it to face the wafer W, so that the gap between the upper plate 30 and the wafer W can be controlled at, e.g., about 0.1-500 mm. During the electroless plating, the wafer W is disposed close to the upper plate 30 to limit the size of the gap (e.g., 2 mm or less of the gap between the wafer W and the upper plate 30), so that the processing solution is uniformly supplied onto the surface of the wafer W and the amount of consumption thereof is reduced.

The lower plate 40 disposed to face the bottom surface of the wafer W is of a substantially circular flat plate type; and supplies heated pure water to the bottom surface of the wafer W to properly heat the wafer W while it being disposed close to the wafer W.

For efficiently heating the wafer W, it is preferable that the size of the lower plate 40 is approximately similar to that of the wafer W. Specifically, it is preferable that the size of the lower plate 40 is greater than 80% or 90% of an area of the wafer W.

The lower plate 40, having a processing solution injection opening 41 on the center of the upper surface thereof, is supported by a supporting portion 42.

The processing solution passing through the supporting portion 42 is discharged through the processing solution injection opening 41. As for the processing solution, there may be used pure water (RT: room temperature) or heated pure water (e.g., in the range from the room temperature to about 60° C.).

The supporting portion 42 penetrating through the hollow motor 12 is connected to an elevating mechanism (not shown) of a gap adjusting unit. By the operation of the elevating mechanism, the supporting portion 42, and further, the lower plate 40 can be vertically moved.

The cup 50, which accommodates therein the wafer chuck 20 and discharges therefrom the processing solution used for the processing of the wafer W, has a cup side portion 51, a cup bottom plate 52 and a waste liquid line 53.

The cup side portion 51 is of a substantially cylindrical shape, wherein the inner periphery thereof is formed along the outer periphery of the wafer chuck 20 and the top portion thereof is disposed in the vicinity of the upper portion of the supporting surface of the wafer chuck 20.

The cup bottom plate 52 connected to the lower portion of the cup side portion 51 has an opening at a position corresponding to the hollow motor 12; and the wafer chuck 20 is disposed at a position corresponding to the opening.

The waste liquid line 53 connected to the cup bottom plate 52 is to discharge from the cup 50 the waste liquid (the processing solution used for the processing of the wafer W) into the waste line or the like of the factory, in which the electroless plating apparatus 10 is installed.

The cup 50 connected to the elevating mechanism (not shown) can be vertically moved with respect to the base 11 and the wafer W.

The nozzle arms 61 and 62 are disposed in the vicinity of the top surface of the wafer W; and fluids such as the processing solution, air and the like are discharged through openings of tip ends thereof. The fluid to be discharged may be selected in a predetermined manner from pure water, liquid chemical or nitrogen gas. To the nozzle arms 61 and 62, there are connected transfer mechanism (not shown) for moving the nozzle arms 61 and 62 in a direction towards the center of the wafer W, respectively. In case where the fluids are discharged onto the wafer W, the nozzle arms 61 and 62 are moved to positions above the wafer. If the discharge is completed, the nozzle arms 61 and 62 are moved away outside the outer periphery of the wafer W. Further, the number of nozzle arms may be one or 3 or more, depending on the amount of the liquid chemical to be discharged or the kind thereof.

One end of the base 11 can be moved upward or downward by the substrate inclining mechanism 70 connected to the base 11, thereby tilting the base by an amount in the range of, e.g., 0˜10° or 0˜5°, and the wafer chuck 20, the wafer W, the upper plate 30, the lower plate 40 and the cup 50, which are connected to the base 11, can be accordingly tilted by the same amount.

FIG. 4 is a partial cross sectional view showing a state where the wafer W and the like are tilted by the substrate inclining mechanism 70. It can be noted that the base 11 is tilted by the substrate inclining mechanism 70, and the wafer W and the like, which are directly or indirectly connected to the base 11, are tilted by an angle θ.

A solution supply unit 80 is to supply heated processing solutions to the upper plate 30 and the lower plate 40, and contains a temperature controlling mechanism 81, processing solution tanks 82, 83 and 84, pumps P1˜P3, valves V1˜V5 and a mixing box 85. Further, FIG. 3 shows a case of using two kinds of liquid chemicals, i.e., the liquid chemicals 1 and 2. However, the numbers of processing tanks, pumps and valves may be set properly depending on the number of liquid chemicals mixed in the mixing box 85.

The temperature controlling mechanism 81 having therein hot water and the processing solution tanks 82˜84 is a device for heating the processing solutions (pure water and liquid chemicals 1 and 2) in the processing solution tanks 82˜84 by using the hot water; and the processing solutions are appropriately heated, e.g., in the range from the room temperature to about 60° C. For example, a water bath, an immersion heater or an external heater may be employed for adjusting the temperature.

The processing solution tanks 82, 83 and 84 are tanks for accommodating therein the pure water, and the liquid chemicals 1 and 2, respectively.

The processing solutions are drawn out from the processing solution tanks 82˜84 by the pumps P1˜P3. Further, the processing solutions may be pushed out from the processing solution tanks 82˜84 by pressurizing the processing solution tanks 82˜84, respectively.

The lines are opened or closed by the valves V1˜V3 to supply or to stop supplying the processing solutions. Further, valves V4 and V5 are to supply pure water of the room temperature (unheated) to the upper plate 30 and the lower plate 40, respectively.

The mixing box 85 is a vessel for mixing the liquid chemicals 1 and 2 from the processing solution tanks 83 and 84.

The liquid chemicals 1 and 2 are appropriately mixed at a predetermined ratio in the mixing box 85 and the temperatures thereof are adjusted therein to thereby be transferred to the upper plate 30. Further, the pure water can be sent to the lower plate 40 at a controlled temperature.

The electroless plating apparatus 10 further includes a control unit 90. The control unit preferably controls an electroless plating processing, a pre-treatment thereof, a cleaning processing after plating, a drying processing, a transfer of the wafer, a supply and discharge of a processing solution and the like, in a completely automated manner by way of controlling, e.g., the supply of the processing solution from the solution supply unit 80 by way of controlling the valves V1˜V5, the temperature of the upper plate 30 and the temperature controlling mechanism 81, and operations of mechanical components, e.g., the cup 50, the nozzle arms 61 and 62, and the substrate inclining mechanism 70. The control unit 90 can be implemented by a general purpose computer, e.g., pc, which has a CPU, a mother board (MB), a hard disk (HD), memories such as ROM and RAM, and a CD/DVD drive. The process control can be carried out under the control of a control program or a software running on the control unit 90. Though not specifically depicted in FIG. 3, control signals are provided from the control unit 90 to the aforementioned components via controller lines (not shown). Further, though not shown in FIG. 3, the electroless plating apparatus 10 can be equipped with various sensors needed to monitor process parameters, e.g., a temperature of the lower plate 40, for the control thereof and monitored signals from the sensors can be fed to the control unit 90. The control program can be programmed on the control unit 90 or can be provided thereto from outside via, e.g., a network or the CD/DVD drive and then stored in, e.g., the hard disk for the execution thereof.

(Details of the Electroless Plating Processings)

As described in FIG. 1, in the electroless plating method in accordance with the first embodiment of the present invention, the wafer W is processed in the order of steps S11˜S18. Hereinafter, the processing sequence will be explained in detail.

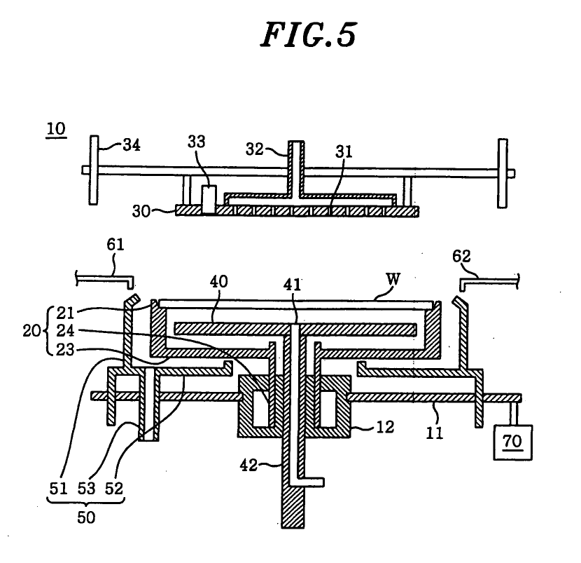

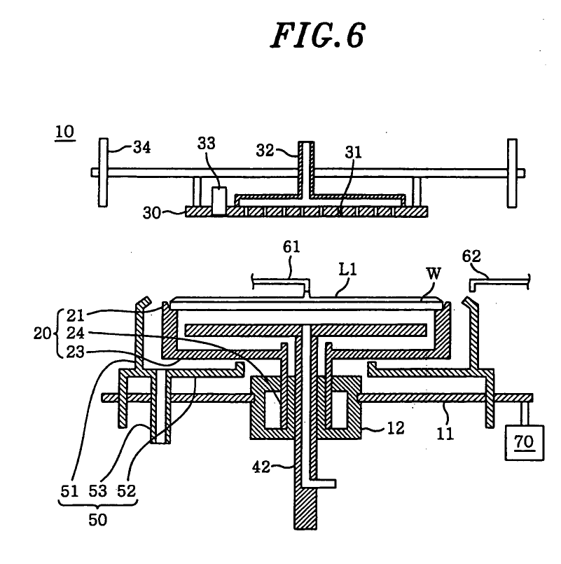

(1) Maintaining the Wafer W (Step S11 and FIGS. 5 and 2A)

The wafer W is maintained on the wafer chuck 20. For example, the wafer W is mounted on the wafer chuck 20 by a suction arm (substrate transfer mechanism) (not shown), on which the wafer W is adsorbed. Further, the wafer W is maintained and fixed by the wafer supporting claws 21 of the wafer chuck 20. Still further, the cup 50 is lowered down, so that the suction arm can be moved in the horizontal direction below the top surface of the wafer W.

(2) Pre-Treatment of the Wafer W (Step S12 and FIG. 6)

Pre-treatment of the wafer W is performed by rotating the wafer W and supplying the processing solution from the nozzle arm 61 or 62 onto the wafer W.

The wafer W is rotated by rotating the wafer chuck 20 with the hollow motor 12, and the rotation speed may be in the range of, e.g., 100˜200 rpm.

Any one or both of the nozzle arms 61 and 62 are moved above the wafer W to discharge the processing solutions. As for the processing solutions supplied from the nozzle arms 61 and 62, there are sequentially supplied, e.g., pure water for cleaning the wafer W and a liquid chemical for activating the catalyzer of the wafer W, depending on the object of the pre-treatment. At this time, the discharge amount may be, e.g., about 100 mL, enough to form a puddle (layer) of the processing solution on the wafer W. However, the discharge amount may be increased, if necessary. Further, the processing solution to be discharged may be appropriately heated (e.g., in the range from room temperature to about 60.

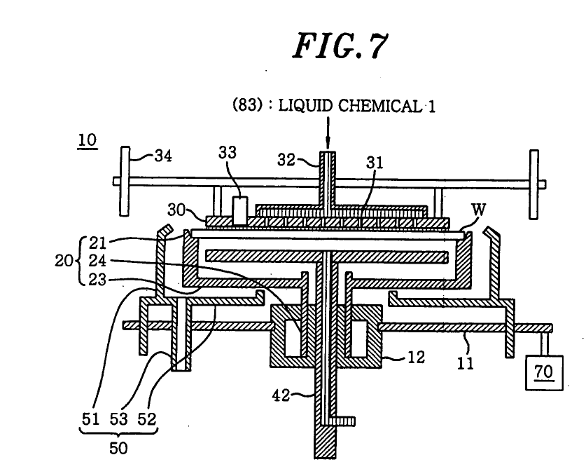

(3) Supplying the Plating Solution Onto the Wafer W and Keeping it Thereon (Step S13 and FIGS. 7 and 2B)

The plating solution is supplied onto the wafer W, and kept thereon.

The upper plate 30 is disposed close to the top surface of the wafer W (e.g., a gap between the top surface of the wafer W and the lower surface of the upper plate 30: about 0.1˜2 mm) to supply the liquid chemical for plating (plating solution) through the processing solution injection openings 31 (e.g., 30˜100 mL/min). Supplied plating solution fills the gap between the top surface of the wafer W and the lower surface of the upper plate 30, and then, is drained out to the cup 50. By disposing the upper plate 30 close to the wafer W, the amount of consumption of the plating solution can be reduced.

At this time, the temperature condition for performing the electroless plating on the wafer W by using the plating solution is not given sufficiently (the temperature is low). Thus, the electroless plating is not started yet. The formation of an electrolessly plated coating on the wafer W is not performed almost, and if any, the formation rate thereof is small.

Therefore, the plating solution may spread sufficiently all over the wafer W. For example, in case where the fine recess portion such as a via hole, a trench or the like is formed in the wafer W, it may be filled with the plating solution.

Further, by rotating the wafer W while the plating solution being supplied thereonto, it is possible to improve the uniformity in the supply of the plating solution on the wafer W.

In the above-described plating solution supply, it may be possible to perform following the processings 1)˜4) together therewith:

1) By rotating the wafer W by the wafer chuck 20 while the plating solution being supplied thereonto, it is possible to uniformly supply the plating solution onto the wafer W. Further, it may attribute to enhance the uniformity in the coating. For example, the wafer W may be rotated at a speed in the range of 10˜50 rpm.

2) The wafer chuck 20 and the upper plate 30 may be tilted by the substrate inclining mechanism 70, prior to (or during or after) the supply of the plating solution.

Since the wafer W is tilted, a gas (e.g., an air) staying in a space between the wafer W and the upper plate 30 is immediately removed, and the space will be refilled with the plating solution. In case where the gas staying in the space between the wafer W and the upper plate 30 is incompletely removed, bubbles will be formed to remain in the space between the wafer W and the upper plate 30, to thereby deteriorate the uniformity in the coating to be formed.

3) After the plating solution of a predetermined amount is supplied onto the wafer W, the supply thereof may be stopped.

By reducing the plating solution supplied onto the wafer W, it is possible to cut the amount of the plating solution used. Since the supply of the plating solution at this step is aimed at spreading the plating solution over the wafer W, the reaction of the plating solution (i.e., consumption of the plating solution) is not an object. Therefore, it is not necessary to perform the supply of the plating solution continuously.

4) It is not absolutely required to dispose the wafer W close to the upper plate 30, and the plating solution may be supplied while the upper plate 30 and the wafer W are separated far away from each other. In this case, the processing 3) (the supply of the plating solution is stopped after it has been supplied by a predetermined amount) is performed together, generally.

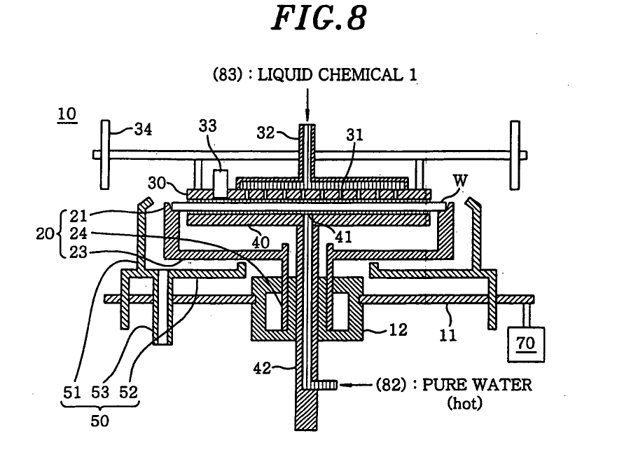

(4) Heating of the Plating Solution (Step S14 and FIGS. 8 and 2C)

The plating solution is heated to an optimum temperature for the reaction (e.g., in the range from room temperature to about 60° C.) to start the formation of the coating by the reaction of the plating solution. At this time, the temperature of the plating solution is measured by using any means, and heating thereof is preferably controlled. Such a temperature measurement may be conducted by directly measuring the temperature of the plating solution itself, but it may be performed by indirectly measuring the temperature thereof, e.g., by measuring that of the wafer W.

Heating of the plating solution can be performed by using respective various techniques, as explained below in the following processings 1)˜4), or by using the combination thereof:

1) Heating by the lower plate 40

This heating technique is shown in FIG. 8.

The lower plate 40 is heated and disposed close to the bottom surface of the wafer W (e.g., a gap between the bottom surface of the wafer W and the upper surface of the lower plate 40: about 0.1˜2 mm); and the pure water heated by the liquid supply unit 80 is supplied through the processing solution injection opening 41. The heated pure water fills the gap between the bottom surface of the wafer W and the upper surface of the lower plate 40 to heat the wafer W. By heating the wafer W, the plating solution is heated, and thus the formation of the coating on the wafer W is performed. In this technique, the plating solution is heated from an interface with the wafer W. The coating is also formed in the interface, so that the heat applied to the plating solution is effectively utilized.

By heating the wafer W by using liquid such as pure water or the like, it becomes easy to rotate the wafer W while maintaining the lower plate 40 not to be rotated. Moreover, the bottom surface of the wafer W can be prevented from being contaminated. Meanwhile, the wafer W may be heated by bring it into contact with the heated lower plate 40, if necessary.

2) Increasing in the temperature of the plating solution to be supplied

The formation of the coating may be started by increasing the temperature of the plating solution, which has been supplied onto the wafer. This increase in the temperature of the plating solution can be performed by using the liquid supply unit 80.

By changing the temperature of the plating solution itself to be supplied, it is possible to improve the stability of the temperature of the plating solution.

3) Heating by the upper plate 30

The plating solution may be also heated by the upper plate 30. The plating solution may be heated by increasing the temperature of the upper plate 30 since the upper plate 30 is in contact with the plating solution.

4) Heating of the plating solution may be performed by using an optimum means such as a radiation heat of a heater, a lamp or the like.

For example, in case where the plating solution is supplied while the upper plate 30 and the wafer W are separated far away from each other, and the supply thereof is stopped after it has been supplied by a predetermined amount, the plating solution can be readily heated by using is the radiation heat of the lamp from the top surface of the wafer W.

In the above-described plating solution heating, it may be possible to perform the following processings 1)˜5) together therewith:

1) By rotating the wafer W by the wafer chuck 20 while the plating solution being heated, it is possible to improve the uniformity in the heating of the plating solution.

Further, it may attribute to enhance the uniformity in the coating. For example, the wafer W may be rotated at a speed in the range of 10˜50 rpm.

2) The wafer chuck 20 and the upper plate 30 may be tilted by the substrate inclining mechanism 70.

Bubbles such as hydrogen and the like may be formed due to the reaction of the plating solution. Since the wafer W is tilted, a gas staying in a space between the wafer W and the upper plate 30 is immediately removed, and thus the uniformity in the coating can be prevented from being deteriorated.

3) The plating solution may be supplied intermittently, not continuously, during the formation of the coating. By efficiently utilizing the plating solution supplied onto the wafer W, it is possible to reduce the amount of the plating solution used.

4) The supply of the plating solution may have been stopped.

In case where the coating is formed by using the plating solution, which has been already supplied onto the wafer. W, the technique of the present embodiment is also useful.

5) The coating may be formed while the upper plate 30 and the wafer W are separated far away from each other. In this case, the processing 4) (the supply of the plating solution is stopped after it has been supplied by a predetermined amount) is performed together, generally.

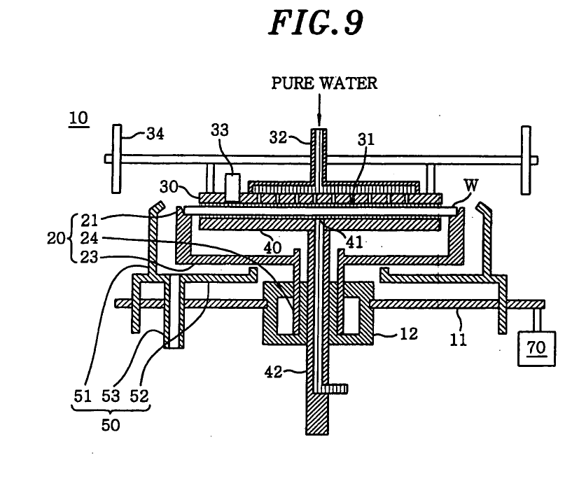

(5) Cleaning of the Wafer W (Step S15 and FIG. 9)

The wafer W is cleaned by using the pure water. Cleaning may be performed by using the pure water as the processing solution to be discharged through the processing solution injection openings 31 of the upper plate 30, instead of using the plating solution. At this time, the pure water may be further supplied from the processing solution injection opening 41 of the lower plate 40.

In cleaning the wafer W, the nozzle arms 61 and 62 may be used. At this time, the supply of the plating solution from the processing solution injection openings 31 of the upper plate 30 is stopped, and the upper plate 30 is moved away from the wafer W. Thereafter, the nozzles 61 and 62 are moved above the wafer W to supply the pure water. In the same manner, it is preferable that the pure water is further supplied from the processing solution injection opening 41 of the lower plate 40.

Since the wafer W is cleaned while it being rotated, the uniformity in cleaning of the wafer can be improved.

Further, in case where the coating is formed while the upper plate 30 and the wafer W are separated far away from each other, it is preferable that the plating solution is discharged from the wafer W prior to the cleaning of the wafer W, in order to improve the cleaning efficiency. For example, the plating solution may be discharged by rotating the wafer W at a high speed.

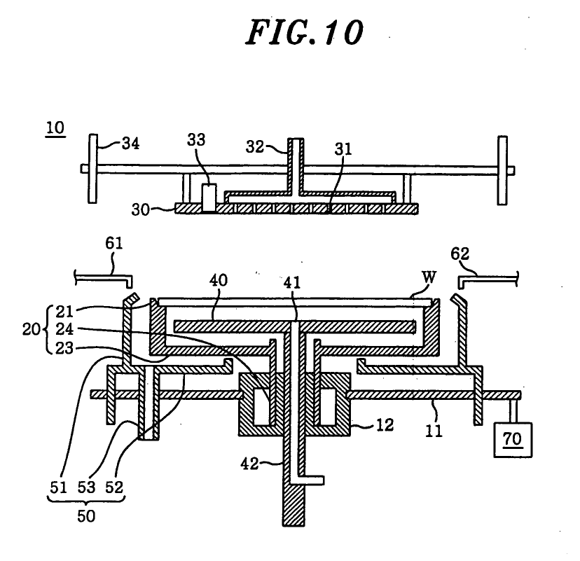

(6) Drying of the Wafer W (Step S16 and FIG. 10)

The supply of the pure water onto the wafer W is stopped, and the wafer W is rotated at a high speed to get rid of the pure water therefrom. Drying of the wafer W may be facilitated by using the nitrogen gas ejected from the nozzle arms 61 and 62, if necessary.

(7) Removing of the Wafer W (Step S17 and FIG. 11)

After drying of the wafer W is completed, the wafer W is released from the wafer chuck 20. Then, the wafer W is removed from the wafer chuck 20 by the suction arm (substrate transfer mechanism) (not shown).

### Second Embodiment

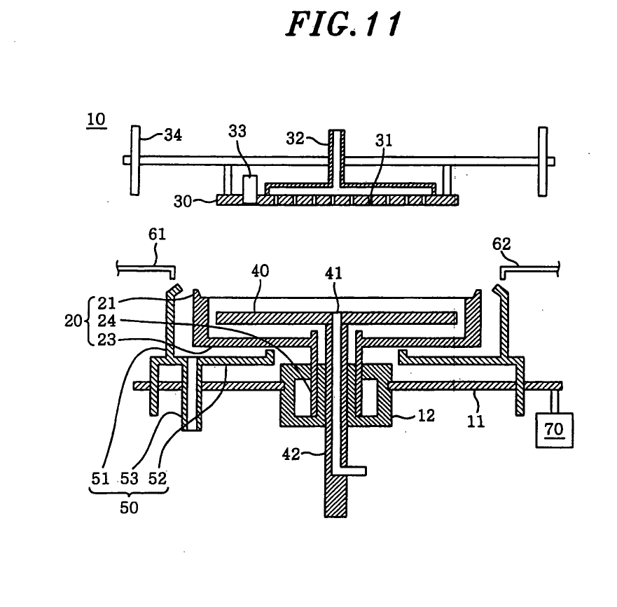

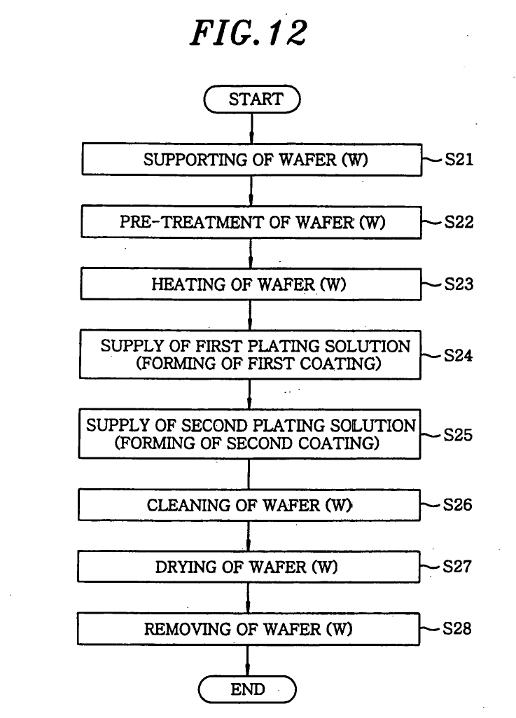

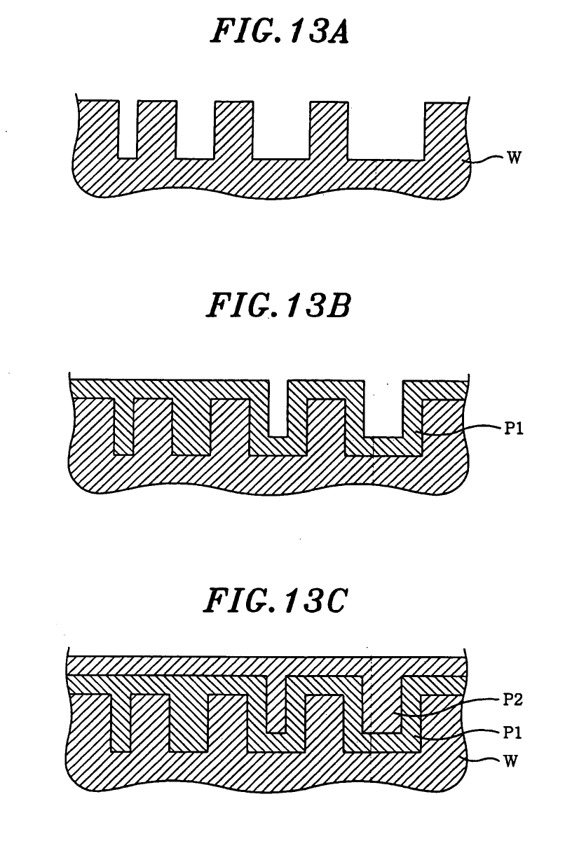

FIG. 12 is a flowchart for showing an exemplary sequence of an electroless plating method in accordance with a second embodiment of the present invention. Further, FIGS. 13A˜13C present cross sectional views for showing cross sectional statuses of the wafer W as the substrate processed by following the sequence described in FIG. 12.

First, a processing of FIG. 12 will now be roughly explained (details will be discussed later).

A first plating solution is supplied onto a wafer W having a recess portion (FIG. 13A) to form a first coating P1 thereon (step S24 and FIG. 13B). Thereafter, a second plating solution is supplied to form a second coating P2 (step S25 and FIG. 13C). At this time, the formation rate of the second coating is greater than that of the first coating.

Accordingly, it may be possible that a fine recess portion (narrow pattern) is filled at step S24 and a relatively wide recess portion (wide pattern) is filled at step S25. As a result, the formation of the coating on the wafer W can be performed uniformly, and further, rapidly.

In the following, the processing sequence described in FIG. 12 will be discussed in detail.

(1) Maintaining of the Wafer N and Pre-Treatment Thereof (Steps S21 and S22, and FIG. 13A)

The wafer W is maintained in the plating apparatus 10, and pre-treatment thereof is performed prior to the plating processing. These steps S21 and S22 correspond to steps S1 and S12 of the first embodiment, respectively, and detailed explanations thereof will be omitted since they are substantially same.

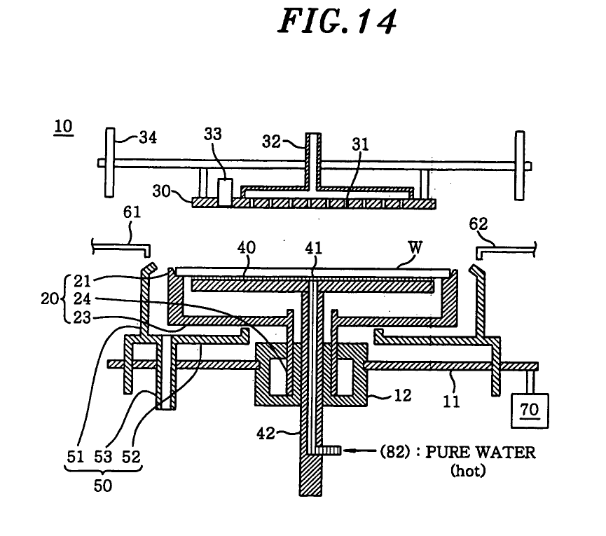

(2) Heating of the Wafer W (Step S23 and FIG. 14)

The heating of the wafer W is performed to maintain the wafer W at an optimum temperature for the reaction of the plating solution.

The lower plate 40 is heated and disposed close to the bottom surface of the wafer W (e.g., a gap between the bottom surface of the wafer W and the upper surface of the lower plate 40: about 0.1˜2 mm); and the pure water heated by the liquid supply unit 80 is supplied through the processing solution injection opening 41. Heated pure water fills the gap between the bottom surface of the wafer W and the upper surface of the lower plate 40 to heat the wafer W.

Further, the water W is heated while it being rotated, so that uniformity in a wafer heating is improved.

By heating the wafer W by using liquid such as pure water or the like, it becomes easy to rotate the wafer W while maintaining the lower plate 40 not to be rotated. Moreover, the bottom surface of the wafer W can be prevented from being contaminated.

The wafer W may be heated by using different heating means. For example, the wafer W may be heated by radiant heat from a heater or lamp. Further, the wafer W may be heated by making a contact with heated lower plate 40, if necessary.

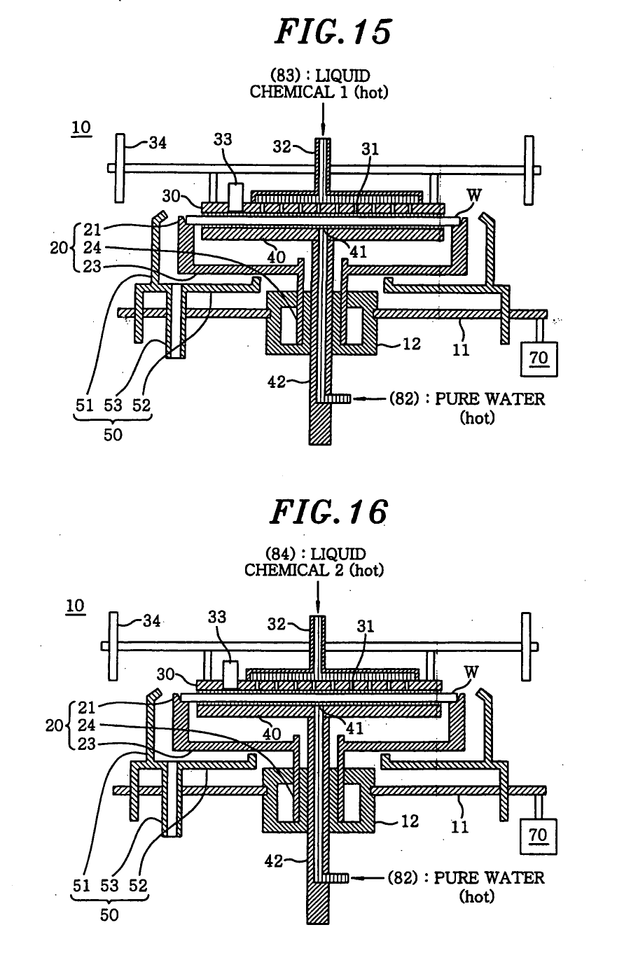

(3) Forming of the First Coating by Supplying the First Plating Solution (Step S24 and FIGS. 15 and 13B)

The upper plate 30 is disposed close to the top surface of the wafer W (e.g., a gap between the top surface of the wafer W and the lower surface of the upper plate 30: about 0.1˜2 mm) to supply the liquid chemical for plating (plating solution) through the processing solution injection openings 31 (e.g., 30˜100 mL/min). Supplied plating solution fills the gap between the top surface of the wafer W and the lower surface of the upper plate 30, and then, is drained out to the cup 50. At this time, the temperature of the plating solution is adjusted by the upper plate 30 (e.g., in the range from room temperature to about 60° C.). Further, it is preferable that the temperature of the plating solution to be supplied has been adjusted by the liquid supply unit 80.

Here, since the wafer W is rotated by the wafer chuck 20, uniformity in the coating to be formed on the wafer W can be improved. For example, the wafer W is rotated at a speed in the range of 10˜50 rpm.

Further, the heating of the upper plate 30 may be performed in advance at any step S21˜S23. By performing the heating of the upper plate 30 in parallel with other processing, the processing time of the wafer W can be reduced.

As mentioned above, the first coating is formed on the wafer W by supplying the first plating solution heated to a predetermined temperature onto the top surface of the wafer W. At this time, the formation rate of the coating is set to be smaller than that of a second coating at following step S25. Since the coating is formed at a relatively low speed, the coating can be securely formed in the fine recess portion of the wafer W.

In the above-described plating solution supply, it may be possible to perform the following processings 1)˜4):

1) By rotating the wafer W by the wafer chuck 20 while the plating solution being supplied thereonto, it is possible to improve the uniformity in the formation of the coating on the wafer W.

2) The wafer chuck 20 and the upper plate 30 may be tilted by the substrate inclining mechanism 70, prior to the supply of the plating solution.

Since the wafer W is tilted, a gas staying in a space between the wafer W and the upper plate 30 is immediately removed, and the space will be refilled with the plating solution. In case where the gas staying in the space between the wafer W and the upper plate 30 is incompletely removed, bubbles will be formed to remain in the space between the wafer W and the upper plate 30, to thereby deteriorate the uniformity in the coating to be formed.

Further, when the coating is formed by using the plating solution, a gas (e.g., hydrogen) is generated and bubbles are produced due to the resultant gas. Thus, the uniformity in the coating may be deteriorated.

Since the wafer W is tilted by the substrate inclining mechanism 70, production of the bubbles is reduced and escape of the resultant bubbles is facilitated. Therefore, the uniformity in the coating can be improved.

3) The plating solution may be supplied intermittently, not continuously, during the formation of the coating. By efficiently utilizing the plating solution supplied onto the wafer W, it is possible to reduce the amount of the plating solution used.

4) After the plating solution of a predetermined amount is supplied onto the wafer W, the supply thereof may be stopped.

By reducing the plating solution supplied onto the wafer W, it is possible to cut the amount of the plating solution used. Since the supply of the plating solution at this step is aimed at spreading the plating solution over the wafer W, the reaction of the plating solution (i.e., consumption of the plating solution) is not an object. Therefore, it is not necessary to perform the supply of the plating solution continuously.

5) It is not absolutely required to dispose the wafer W close to the upper plate 30, and the plating solution can be supplied while the upper plate 30 and the wafer W are separated far away from each other. In this case, the processing 4) (the supply of the plating solution is stopped after it has been supplied by a predetermined amount) is performed together, generally.

(4) Forming of the Second Coating by Supplying the Second Plating Solution (Step S25 and FIGS. 16 and 13C)

A second plating solution is used as a plating solution to be supplied through the processing solution injection openings 31 instead of the first plating solution. By supplying the second plating solution, a second coating is formed on the wafer W. At this time, the formation rate of the coating is set to be greater than that of the first coating at prior step S24. The formation of the coating on the wafer W is performed rapidly.

Since the fine pattern has been filled with the first coating at step S24, the relatively wide pattern is filled at this step.

At this time, by allowing the first and the second coating to have the same quality, it is possible to improve the homogeneity in the formation of the coating on the wafer W.

As mentioned above, by using the plating solution having a different formation rate of the coating, it is possible to perform uniformly and rapidly the plating on the wafer W, on which the fine patterns (recesses) have been formed.

By changing the respective composition ratios of the first and the second plating solution, it is possible to vary formation rates of the coatings, which have the same quality. For example, by changing concentration or pH of the metal salt, it is possible to change the formation rate of the coating.

The change in a composition of the plating solution may be carried out by changing a tank, which supplies the plating solution to be used. Alternatively, it may be performed by changing a mixing ratio of solutions that are mixed in the mixing box 85.

In case where the coating is formed while the upper plate 30 and the wafer W are separated far away from each other, the first plating solution may be discharged from the wafer W prior to the supply of the second plating solution, in order to prevent the first plating solution from being mixed with the second plating solution. For example, the plating solution may be discharged by rotating the wafer W at a high speed. Additionally, the wafer W may be cleaned by using the pure water or the like.

(5) Cleaning, Drying and Removing of the Wafer W (Steps S26˜S28)

The wafer W is cleaned, dried and removed from the electroless plating apparatus 10. These steps S26˜S28 correspond to steps S15˜S27 of the first embodiment, respectively, and detailed explanations thereof will be omitted since they are substantially same.

### Other Embodiments

While the present invention is not limited to the aforementioned embodiments, it will be understood by those skilled in the art that various changes and modifications thereof may be made without departing from the spirit.

For example, a glass substrate or the like other than the wafer W may be used as a substrate.

Further, in the first and the second embodiment, the formation rates of the coatings are changed by varying the temperature and by changing the plating solution, respectively. However, the formation rates of the coatings may be changed by reaction conditions of the plating solution (e.g., temperature and composition thereof (e.g., concentration and pH of metal ions)).

In the electroless plating method in accordance with the present invention, it is possible to improve the uniformity in the coating to be formed. Accordingly, the present invention has an industrial applicability.

While the invention has been shown and described with respect to the preferred embodiments, it will be understood by those skilled in the art that various changes and modifications may be made without departing from the spirit and scope of the invention as defined in the following claims.

1. An electroless plating method comprising:
a plating solution supplying step of supplying an electroless plating solution onto a substrate;
a reaction acceleration condition applying step of applying a reaction acceleration condition for accelerating a reaction to the electroless plating solution supplied onto the substrate at the plating solution supplying step; and
a coating formation step of forming a coating on the substrate by using the electroless plating solution to which the reaction acceleration condition has been applied at the reaction acceleration condition applying step.

2. The electroless plating method of claim 1, wherein the reaction acceleration condition corresponds to an increase in a temperature of the electroless plating solution.

3. The electroless plating method of claim 2, wherein the increase in the temperature of the electroless plating solution is realized by heating the electroless plating solution by using the substrate.

4. The electroless plating method of claim 2, wherein the increase in the temperature of the electroless plating solution is realized by heating the electroless plating solution by using a radiation heat.

5. The electroless plating method of claim 2, wherein the increase in the temperature of the electroless plating solution is realized by controlling the temperature of the electroless plating solution supplied onto the substrate.

6. The electroless plating method of claim 1, wherein the reaction acceleration condition corresponds to a change in a composition of the electroless plating solution.

7. The electroless plating method of claim 6, wherein the change in the composition of the electroless plating solution is realized by changing an electroless plating solution to be supplied onto the substrate.

8. The electroless plating method of claim 6, wherein the change in the composition of the electroless plating solution is realized by changing a mixing ratio of plural liquid chemicals forming an electroless plating solution to be supplied onto the substrate.

9. An electroless plating method comprising:
a first coating formation step of forming a first coating on a substrate by using a first electroless plating solution at a first coating formation rate; and
a second coating formation step of forming a second coating on the substrate, on which the first coating has been formed at the first coating formation step, by using a second electroless plating solution at a second coating formation rate higher than the first coating formation rate.

10. The electroless plating method of claim 9, further comprising, prior to the second coating formation step, an electroless plating solution removal step of removing from the substrate the first electroless plating solution which has been used in the first coating formation step.

11. The electroless plating method of claim 9, wherein the first and the second plating solution are supplied from different plating solution storing units, respectively.

12. The electroless plating method of claim 9, wherein the first and the second plating solution are supplied via a liquid chemical mixing unit for mixing plural liquid chemicals.

13. A computer readable storage medium storing therein a program for controlling an electroless plating apparatus using an electroless plating method, the method comprising:
a plating solution supplying step of supplying an electroless plating solution onto a substrate;
a reaction acceleration condition applying step of applying a reaction acceleration condition for accelerating a reaction to the electroless plating solution supplied onto the substrate at the plating solution supplying step; and
a coating formation step of forming a coating on the substrate by using the electroless plating solution to which the reaction acceleration condition has been applied at the reaction acceleration condition applying step.

14. The computer readable storage medium of claim 13, wherein the reaction acceleration condition corresponds to an increase in a temperature of the electroless plating solution.

15. The computer readable storage medium of claim 14, wherein the increase in the temperature of the electroless plating solution is realized by heating the electroless plating solution by using the substrate.

16. The computer readable storage medium of claim 14, wherein the increase in the temperature of the electroless plating solution is realized by heating the electroless plating solution by using a radiation heat.

17. The computer readable storage medium of claim 14, wherein the increase in the temperature of the electroless plating solution is realized by controlling the temperature of the electroless plating solution supplied onto the substrate.

18. The computer readable storage medium of claim 13, wherein the reaction acceleration condition corresponds to a change in a composition of the electroless plating solution.

19. The computer readable storage medium of claim 18, wherein the change in the composition of the electroless plating solution is realized by changing an electroless plating solution to be supplied onto the substrate.

20. The computer readable storage medium of claim 18, wherein the change in the composition of the electroless plating solution is realized by changing a mixing ratio of plural liquid chemicals forming an electroless plating solution to be supplied onto the substrate.

21. A computer readable storage medium storing therein a program for controlling an electroless plating apparatus using an electroless plating method, the method comprising:
a first coating formation step of forming a first coating on a substrate by using a first electroless plating solution at a first coating formation rate; and
a second coating formation step of forming a second coating on the substrate, on which the first coating has been formed at the first coating formation step, by using a second electroless plating solution at a second coating formation rate higher than the first coating formation rate.

22. The computer readable storage medium of claim 21, further comprising, prior to the second coating formation step, an electroless plating solution removal step of removing from the substrate the first electroless plating solution which has been used in the first coating formation step.

23. The computer readable storage medium of claim 21, wherein the first and the second plating solution are supplied from different plating solution storing units, respectively.

24. The computer readable storage medium of claim 21, wherein the first and the second plating solution are supplied via a liquid chemical mixing unit for mixing plural liquid chemicals.

25. An electroless plating apparatus comprising:
a plating solution supply unit for supplying an electroless plating solution onto a substrate;
a reaction acceleration condition applying unit for applying a reaction acceleration condition to the electroless plating solution supplied onto the substrate by the plating solution supplying unit; and
a coating formation unit for forming a coating on the substrate by using the electroless plating solution to which the reaction acceleration condition has been applied by the reaction acceleration condition applying unit.

26. An electroless plating apparatus comprising:
a first coating formation unit for forming a first coating on a substrate by using a first electroless plating solution at a first coating formation rate; and
a second coating formation unit for forming a second coating on the substrate, on which the first coating has been formed by the first coating formation unit, by using a second electroless plating solution at a second coating formation rate higher than the first coating formation rate.
